(19) United States
(12) Patent Application Publication
(10) Pub. No.: US 2017/0280685 A1
(43) Pub. Date: Oct. 5, 2017

(54) DOG STEERING HARNESS

(71) Applicant: Theresa M. McCAIN, Holly Springs, GA (US)

(72) Inventor: Theresa M. McCAIN, Holly Springs, GA (US)

(21) Appl. No.: 15/085,119

(22) Filed: Mar. 30, 2016

(51) Int. Cl. A01K 27/00

(52) U.S. Cl. CPC A01K 27/002

(57) ABSTRACT

A steering harness is provided. The steering harness couples a shoulder harness and a neck apparatus so that a front/chest attachment is provided for controlled steering and guiding of the dog, whereby the front/chest attachment is disposed to prevent choking and is secured from being displaced.

### BACKGROUND OF THE INVENTION

The present invention relates to dog harnesses and, more particularly, to a dog steering harness adapted to provide a front/chest attachment for control of the dog, whereby the front/chest attachment prevents choking and is secured from falling below the chest onto the dog's legs.

Training a dog involves attaching a leash to either a collar or harness. Typically, the only choices for collars are choke collars, flat collars, or prong or pinch type collars. The current choke collars and prong collars are used for the “pop-n-jerk” method of training, which operated on a negative leash/collar correction when the dog did not respond appropriately. A flat collar is typically not effective on most dogs, especially dogs that pull when on a leash.

And unfortunately, the flat collars result in “opposition reflex” pulling because they apply pressure on the dog's trachea, esophagus or thyroid gland. As a result, such apparatuses are counterproductive means for humanely training a dog.

As can be seen, there is a need for a dog steering harness adapted to provide a front/chest attachment for control of the dog, whereby the front/chest attachment prevents choking yet is secured from being displaced.

### SUMMARY OF THE INVENTION

In one aspect of the present invention, a steering harness includes a shoulder harness having a shoulder strap coupled to a torso strap, forming a first loop dimensioned and adapted to encircle a girth of a dog, wherein each opposing end of the shoulder strap is coupled to a respective opposing end of the torso strap by a strap ring connector; a neck apparatus having a neck strap coupled to a neck loop, forming a second loop dimensioned and adapted to encircle a neck of a dog, wherein each opposing end of the neck strap is coupled along the neck loop by a first double loop connector; a tension strap interconnecting each strap ring connector to the neck loop by a second double loop connector; and a D-ring attached along the neck loop.

In another aspect of the present invention, the steering harness includes a shoulder harness having a shoulder strap coupled to a torso strap, forming a first loop dimensioned and adapted to encircle a girth of a dog, wherein each opposing end of the shoulder strap is coupled to a respective opposing end of the torso strap by a strap ring connector, wherein each strap ring connector defines a circular shape; a neck apparatus having a neck strap coupled to a neck loop, forming a second loop dimensioned and adapted to encircle a neck of a dog, wherein each opposing end of the neck strap is coupled along the neck loop by a first loop connector; a tension strap interconnecting each strap ring connector to the neck loop by a second loop connector, wherein the two second loop connectors are disposed between the two first loop connectors along the neck loop, and wherein each of the first and second loop connectors defines a rectangular shape for fixing the angle of attachment; a D-ring attached along the neck loop; a buckle provided by the torso strap; and at least one adjustable slider provided along each of the neck strap, the shoulder strap, and the torso strap.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a schematic view of an exemplary embodiment of the present invention, illustrating where to deploy the present invention;

FIG. 4 is a top perspective view of an exemplary embodiment of the present invention, shown in use;

FIG. 5 is a top perspective view of an exemplary embodiment of the present invention; illustrating how to deploy the present invention;

FIG. 6 is a top perspective view of an exemplary embodiment of the present invention, shown in use; and

FIG. 7 is a perspective view of an exemplary embodiment of the present invention, illustrating how it is deployed.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a steering harness. The steering harness couples a shoulder harness and a neck apparatus so that a front/chest attachment is provided for controlled steering and guiding of the dog, whereby the front/chest attachment is disposed to prevent choking and is secured from being displaced.

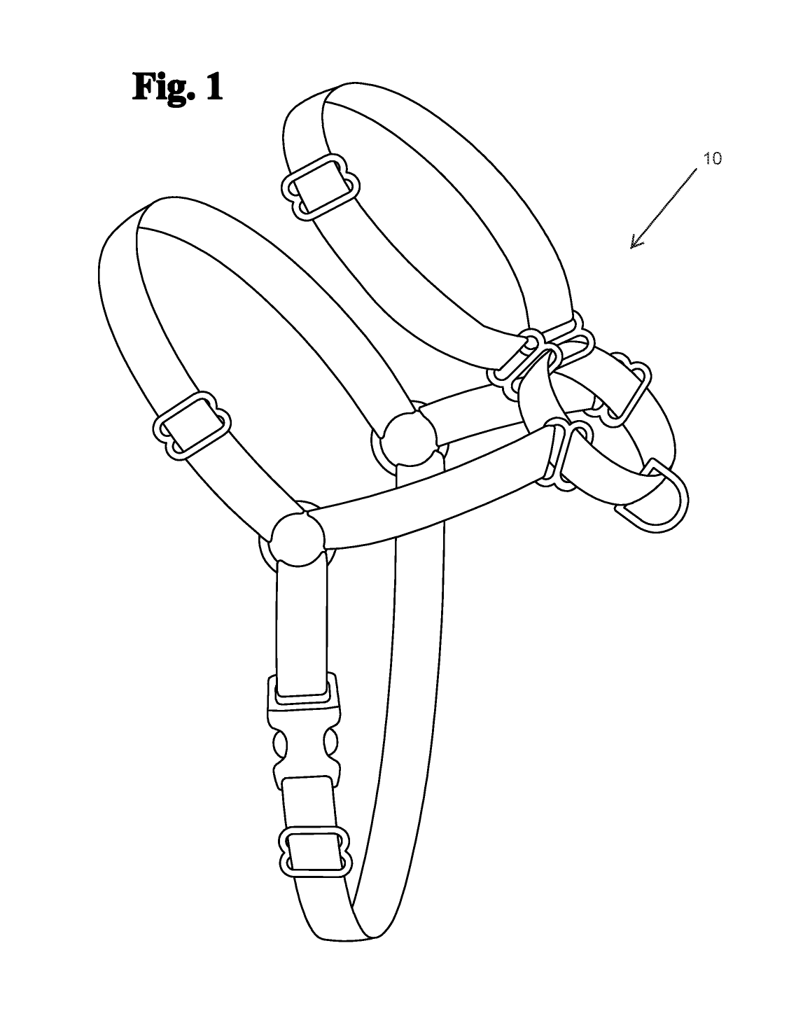

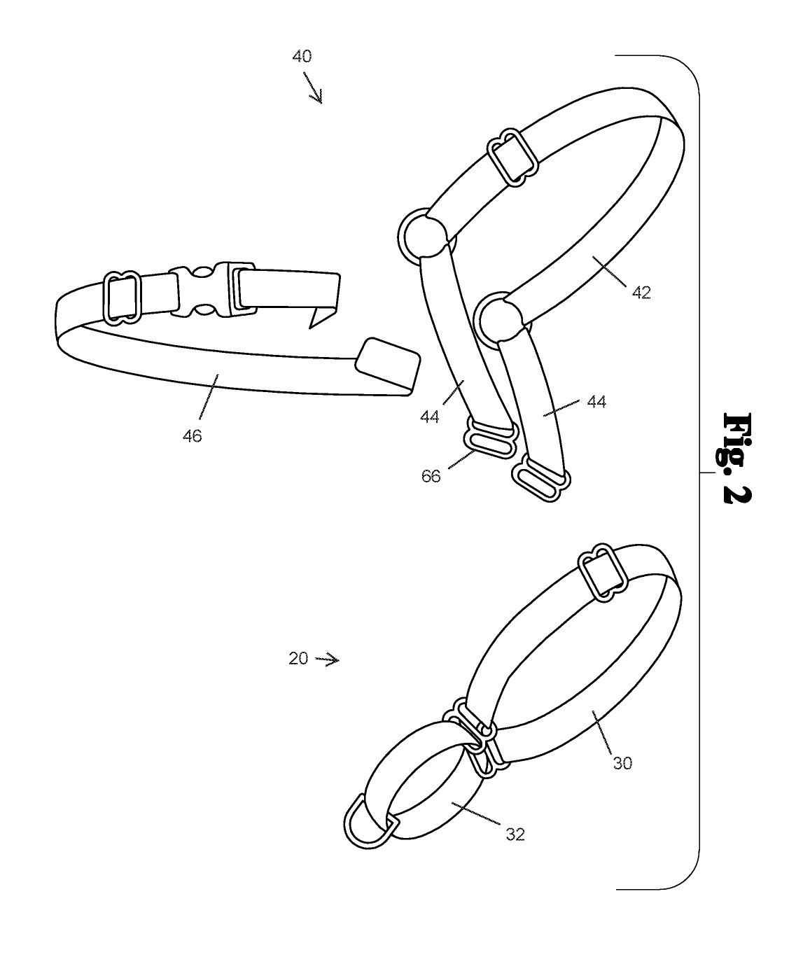

Referring to FIGS. 1 through 7, the present invention may include a steering harness 10 for controlling a dog 90 through a front/chest attachment so as to prevent choking, while securing the front/chest attachment from being displaced.

The steering harness 10 may include a neck apparatus 20 coupled to a shoulder harness 40. The shoulder harness 40 may include a shoulder strap 42, a torso strap 46, and two tension straps 44. The opposing ends of the shoulder strap 42 may be attached to the opposing ends of the torso strap 46 by way of two strap connectors 62, forming a loop dimensioned and adapted to extend around the shoulders and the torso of the dog 90, as illustrated, as illustrated in FIG. 4. A buckle 60 is attached at any point along the torso strap 46 to allow the torso strap 46 strap to be opened and closed for securing the shoulder harness 40 to the dog 90.

The strap connector 62 is a ring made of a durable material defining a circle, to which at least two straps may be attached. The circular shape permits a change of direction of the straps passing through or attached to it, providing comfort and adjustability.

Each of the shoulder and torso straps 42 and 46 may include an adjustable slide 64 for adjusting their lengths. The adjustable slide 64 may be narrow rectangular connector with the center bar separating two openings, wherein a strap may terminate at the center bar by connecting thereto, while an earlier portion of the strap passes through one opening, over the center bar, and through the second opening. The proportions of the adjustable slide 64 relative to the strap material are such that the center bar strap can be pulled with a firm force, but normal movements of the dog 90 will not cause slipping, thereby allowing a user to adjust the length of the strap relative to the portion of the dog 90 secure therein.

Each tension strap 44 may terminate at and connect to each strap connector 62 so as to extend to the neck apparatus 20 by way of rectangular loop connectors 66. The rectangular loop connector 66 may be narrow rectangular connectors with a center bar separating two openings, as illustrated in FIG. 1. The rectangular shape does not permit any change of directions of the straps passing through it, and so may be used to established a fixed angle of attachment. In certain embodiments, the rectangular loop connectors 66 may not have a center bar and thus be a singular rectangular shape, as illustrated in FIGS. 4 through 6.

The neck apparatus 20 may include a neck strap 30 coupled to a neck loop 32 by way of rectangular connectors 66 interconnecting the opposing ends of the neck strap 30 to the closed loop of the neck loop 32, as illustrated in the Figures. The tension straps 44 also are connected to the closed loop of the neck loop 32 by way of the aforementioned double rectangular connectors 66. The neck strap 30 may utilize its own adjustable slide 64 to facilitate adjustability of the loop dimensioned and adapted to encircle a portion of the neck of the dog 90.

The neck loop 32 may be passed through a D-ring 24 before its loop is stitched closed. The D-ring 24 connector facilitates a leash attachment because rotation is allowed along the curved half of the D-ring 24 whereas no rotation is permitted on the flat half of the D-ring 24 so that the flat side may be engaged with neck loop 32 of the neck apparatus 20, enabling the D-ring 24 to move freely there along the neck loop 32. As a result, a leash (not shown) may be attached to the semicircular side of the D-ring so that when the leash is pulled, the pull is transmitted to the D-ring 24 and thus the neck loop 32, which in turn passes through the rectangular loop connectors 66 interconnecting the far ends of the neck strap 30, bringing them closer together and decreasing the diameter of the neck strap 30, thereby providing a snugging effect.

Furthermore, the neck strap 30 prevents the neck loop 32, when subject to at least a portion of a downward force/load including gravitational forces, from being pulled downward, towards the paws of the dog 90. Whereby the arrangement of the shoulder harness 40 and neck apparatus 20 secures the neck loop below dog's trachea, esophagus or thyroid gland, thereby preventing choking of the dog 90 when pulling on the leash.

Webbing or any suitable material may be used for the straps of the neck apparatus 20 and the shoulder harness 40. The webbing may be made of nylon, cotton or other materials that afford comfort and adjustability.

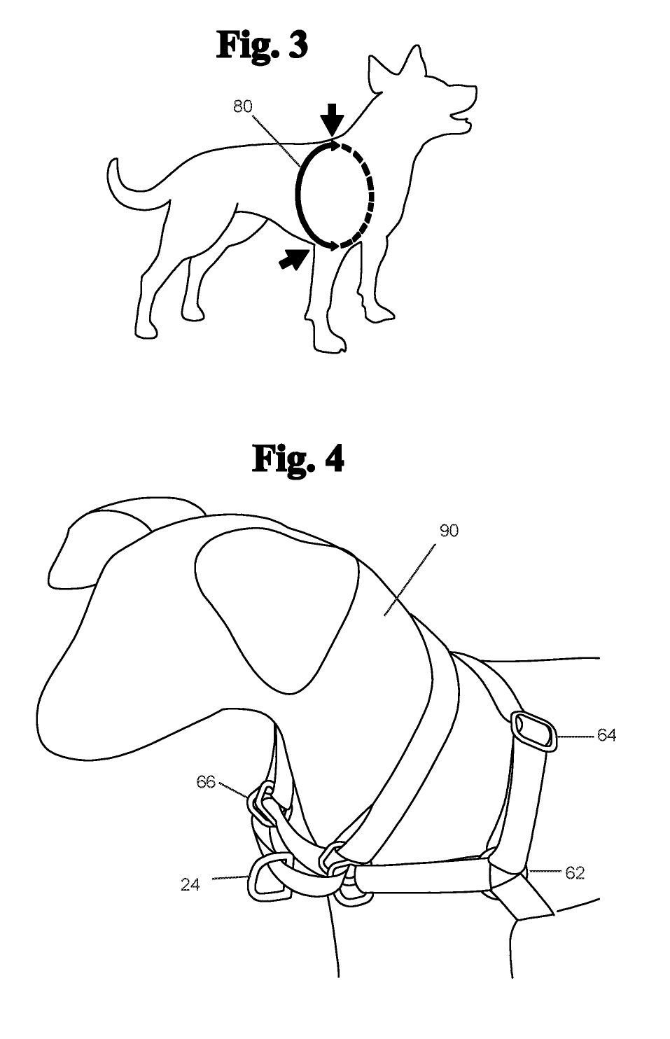

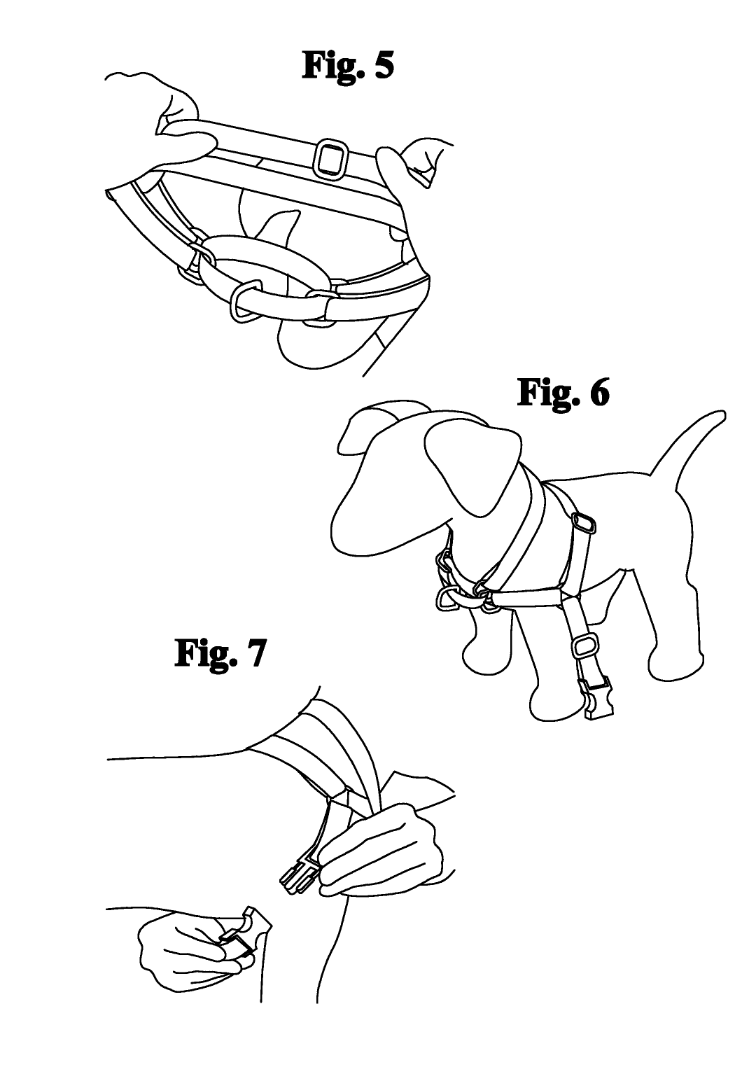

A method of using the present invention may include the following. A user may determine an associated girth 80 of a dog 90 they desire to train, the girth 80 generally being the circumference defined by the rib cage and under the pits of the dog 90, as illustrated in FIG. 3. Using the determined girth 80 to suitably adjust the loop formed by the shoulder and torso straps 42 and 46, the user may simultaneously slip that loop and the loop formed by the neck strap 30 over the head of the dog 90, as illustrated in FIG. 5, so that the neck loop 32 rests generally parallel with the supporting surface and disposed slightly below the dog's trachea, as illustrated in FIG. 6. Then user may secure the buckle 60 of the torso strap 46, and adjust the adjustable slides 64 of the neck strap 30, the torso strap 46 and/or the shoulder strap 42 so that the neck strap 30 is secured to be generally parallel with the supporting surface, disposed slightly below the dog's trachea, and retained from sliding down by the shoulder harness 40, specifically the tension in the opposing tension straps 44. The rectangular loop connectors 66 between the neck loop 32 and both the opposing ends of the neck strap 30 and the two opposing tension straps 44, respectively, fix the neck loop 32 at such a disposition.

The user may attach the leash to the D-ring 24 so as to guide and steer the dog 90 from the front/chest attachment so to eliminate the “opposition” reflex and not pressure the dog's trachea, esophagus or thyroid gland, while humanely training the dog 90 from its first days and throughout its entire lifetime.

It should be understood, of course, that the foregoing relates to exemplary embodiments of the invention and that modifications may be made without departing from the spirit and scope of the invention as set forth in the following claims.

What is claimed is:

1. An apparatus, comprising:
a shoulder harness comprising a shoulder strap coupled to a torso strap, forming a first loop dimensioned and adapted to encircle a girth of a dog, wherein each opposing end of the shoulder strap is coupled to a respective opposing end of the torso strap by a strap ring connector;
a neck apparatus comprising a neck strap coupled to a neck loop, forming a second loop dimensioned and adapted to encircle a neck of a dog, wherein each opposing end of the neck strap is coupled along the neck loop by a first loop connector;
a tension strap interconnecting each strap ring connector to the neck loop by a second loop connector; and
a D-ring attached along the neck loop.

2. The apparatus of claim 1, wherein the two second loop connectors are disposed between the two first loop connectors along the neck loop.

3. The apparatus of claim 1, wherein each of the first and second loop connectors defines a rectangular shape for fixing the angle of attachment.

4. The apparatus of claim 1, wherein each strap ring connector defines a circular shape.

5. The apparatus of claim 1, further comprising a buckle provided by the torso strap.

6. The apparatus of claim 1, further comprising at least one adjustable slider provided along each of the neck strap, the shoulder strap, and the torso strap.

7. An apparatus, comprising:
a shoulder harness comprising a shoulder strap coupled to a torso strap, forming a first loop dimensioned and adapted to encircle a girth of a dog, wherein each opposing end of the shoulder strap is coupled to a respective opposing end of the torso strap by a strap ring connector, wherein each strap ring connector defines a circular shape;
a neck apparatus comprising a neck strap coupled to a neck loop, forming a second loop dimensioned and adapted to encircle a neck of a dog, wherein each opposing end of the neck strap is coupled along the neck loop by a first loop connector;
a tension strap interconnecting each strap ring connector to the neck loop by a second loop connector, wherein the two second loop connectors are disposed between the two loop connectors along the neck loop, and wherein each of the first and second loop connectors defines a rectangular shape for fixing the angle of attachment;
a D-ring attached along the neck loop;
a buckle provided by the torso strap; and
at least one adjustable slider provided along each of the neck strap, the shoulder strap, and the torso strap.
